(19) United States
(12) Patent Application Publication
(10) Pub. No.: US 2019/0193291 A1
(43) Pub. Date: Jun. 27, 2019

(54) SYSTEM AND METHOD OF CUTTING MOLDING MATERIAL

(71) Applicant: Monument Tools, Mesa, AZ (US)

(72) Inventors: Mike Rose, Mesa, AZ (US); Tony Carcione, San Jose, CA (US); Gus Carcione, Mesa, AZ (US)

(21) Appl. No.: 15/899,350

(22) Filed: Feb. 19, 2018

Related U.S. Application Data
(60) Provisional application No. 62/480,582, filed on Apr. 3, 2017.

(51) Int. Cl. B26B 9/02; B25G 1/10

(52) U.S. Cl. CPC B26B 9/02; B26B 5/00; B25G 1/102

(57) ABSTRACT

A bent knife is provided including a handle, a cutting head, and an engaging mechanism configured to removably couple a blade to the cutting head. The blade end of the handle can be tapered up the handle to a predetermined distance. The cutting head can include a housing coupled to a base. The housing can include a recess that can be configured to hold the blade between the housing and the base. The base can include a substantially flattened and a bent portion of the blade end portion of the handle. The bent portion of the base can include a curved portion or an angled bent portion. The engaging mechanism may include a pin configured to fit within a pin hole on the housing and within a reentrant opening on the blade and a leaf spring configured to fit within a depression on the recess. In addition, a method for assembling a bent knife is described herein which can include bending a tube to form a base end and a handle end. The housing may include a recess configured to hold a blade between the housing and the base. An engaging mechanism may be included in the cutting head, the engaging mechanism configured to removably couple a blade to the housing.

### CROSS-REFERENCE TO RELATED APPLICATIONS

This application claims benefit from currently pending U.S. Provisional Application No. 62/460,582 titled “Bent Knife” and having a filing date of Feb. 17, 2017, all of which is incorporated by reference herein.

### FIELD OF THE INVENTION

The present invention relates to tools for holding a knife or knives, and in particular a system and method of cutting molding material.

### BACKGROUND

Knives are known in the art. Typical knives range from simple utility knives to blades connected to complex pivot arms designed to maintain cutting angles in difficult orientations. Many knives seek to provide secure attachment of an inexpensive blade (usually a razor blade) to a holder designed to promote ease of use for a particular application. Other factors, including safety, may also play a part. Use of a razor blade in cutting the molding material that holds vehicle windshields and other windows to the vehicle is particularly challenging, requiring entry of the blade into narrow spaces and often requiring the user to reach some distance across the vehicle while cutting.

Conventionally, removal of windshields and other vehicle windows has been accomplished by attaching a razor blade to a long, straight handle. The long handle extends the reach of the user which is particularly useful when removing of windshields. To attach the blade to the handle, conventional knives use a head portion which contains an opening configured to hold the razor blade. Often, the head and handle portions are manufactured as a single piece from a hollow pipe material, with the head formed by flattening part of the pipe. With straight knife designs, however, the blade is often at risk for breakage when the user applies leverage from the full length of the handle. Also, since the handle is straight, obtaining sufficient leverage for cutting can be awkward for the user.

### BRIEF SUMMARY OF THE INVENTION

Aspects disclosed herein relate to a bent knife and a method of manufacture thereof. The bent knife system may include a handle, a cutting head, a blade, and an engaging mechanism wherein the handle can have a holding end and a blade end. The holding end can have a tapered transition at a predetermined distance to the blade end, wherein the blade end can have a bent portion that leads into a base. The base may include a substantially flattened and bent portion of the blade end. The bent portion of the base may include a curved bent portion or an angled bent portion. The cutting head can include a leaf spring or spring element, and a housing wherein the housing can include a recess configured to hold the blade between the housing and the base. The housing can further comprise a pin hole, and a depression wherein the depression can be substantially oblong comprising two shorter sides of substantially similar dimensions, two longer sides of substantially similar dimensions, and rounded corners and the leaf spring can be configured to fit at least partially within the oblong depression. The oblong depression may be angled such that the longer sides of the oblong depression may be substantially parallel to a plane formed by the handle. The housing can be coupled to the base with the leaf spring substantially between the housing and the base, and set within the depression. A pin can be inserted into the pin hole, and the combination of the pin, the leaf spring, and the recess can form an engaging mechanism. The engaging mechanism can substantially secure the blade when inserted in-between the base and the housing, and the leaf spring can substantially presses up against the blade, and the pin engages at least one of the blade's notches.

In another aspect, a method for assembling a knife frame is disclosed. The method may include bending a tube to form a blade end and a handle end such that a plane of the handle end forms an angle substantially acute to a plane of a bottom of the blade end and the base. From the blade end extending part way up the handle, the handle may be tapered. The base may be flattened to form two sidewalls adjacent to one another, and then one side wall may be removed to form a flat and slim base configured to receive a housing (e.g. half of the flattened tubing at the blade end including the base is removed). The housing may then be coupled to the base to form a cutting head. The housing may include a recess configured to hold a blade between the housing and the base, a depression, and a pin hole. Before coupling the base to the housing a spring element can be placed into the depression, and a pin can be attached to the housing. An engaging mechanism may be included in the cutting head, the engaging mechanism configured to removably couple a blade to the housing.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1A is a bottom, front perspective view of an implementation of a utility knife frame and blade;

FIG. 1B is an exploded, perspective view of the implementation of FIG. 1A; and

FIG. 2 is a partial cross-sectioned perspective view of the implementation of FIG. 1A.

Elements and acts in the figures are illustrated for simplicity and have not necessarily been rendered according to any particular sequence or embodiment.

### DETAILED DESCRIPTION OF THE INVENTION

This document features bent knife frame system and method implementations. There are many features of bent handle knife frame system and method implementations disclosed herein, of which one, a plurality, or all features or steps may be used in any particular implementation. The foregoing and other aspects, features, and advantages will be apparent to those of ordinary skill in the art from this DESCRIPTION and the DRAWINGS.

In the following description, reference is made to the accompanying DRAWINGS which form a part hereof, which can show by way of illustration possible implementations. It is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

Structure

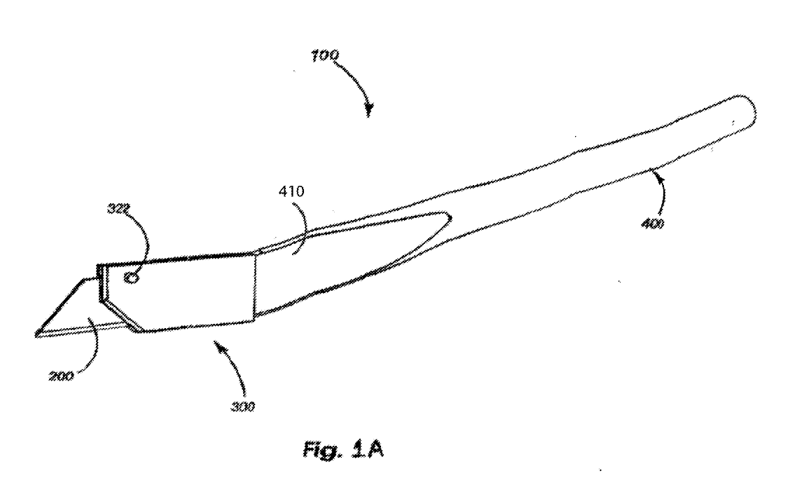

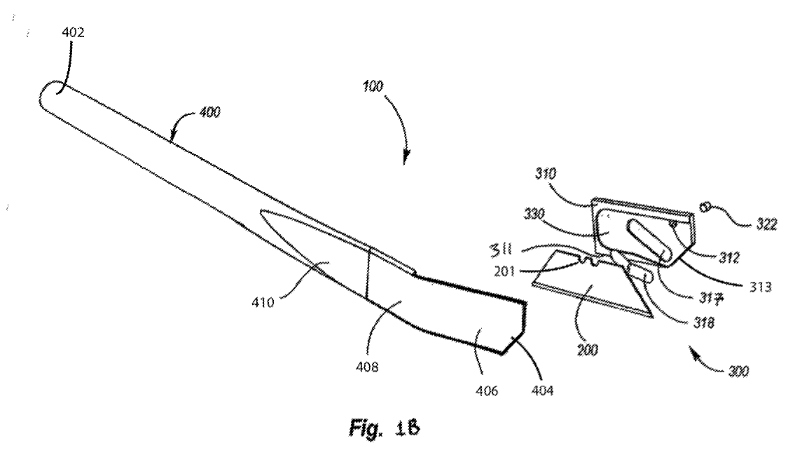

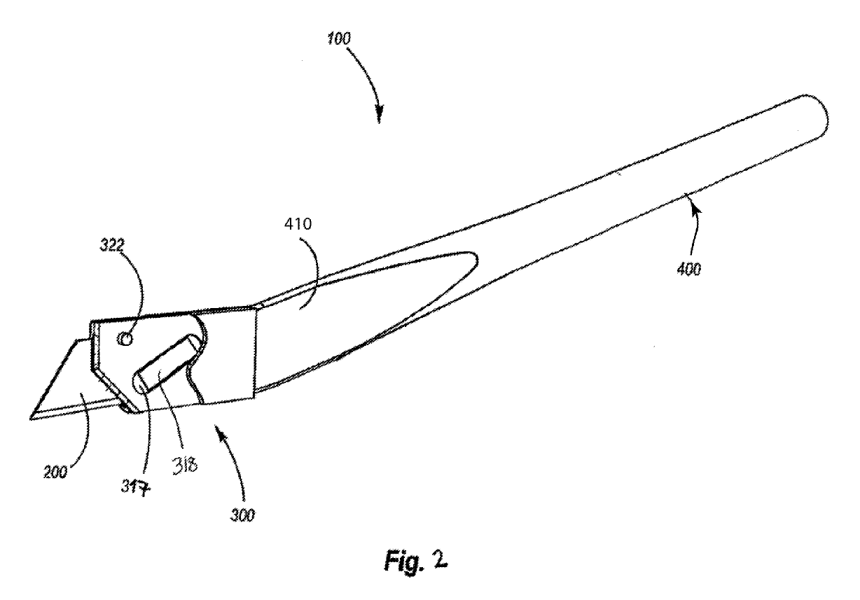

Referring initially to FIGS. 1A-2, an implementation of a bent knife 100 is shown. In the implementation shown, the bent knife 100 comprises a blade 200, a cutting head 300 or holder, and a handle 400.

The handle may comprise a holding end 402, and a blade end 404 having a base 406. The base 406 comprises a section of the handle 400 crimped or flattened such that a relatively flat surface is formed from either a double or single wall of the flattened tube end. In other implementations, the base 406 may comprise a plate or shaped object coupled to the handle. In these and other implementations, the base 406 may be coupled to the handle 400 by welding, soldering, fusing, mechanical fasteners, press fitting, resins or glues, or other known coupling methods. In still other implementations, the base 406 and the cutting head 300 may be manufactured as one piece and attached to the handle 400 by welding, soldering, mechanical fasteners, press fitting, resins or glues, or other known coupling methods.

In an implementation the handle 400 can comprise an angled bent portion 408, the bend may comprise a corner wherein two planes diverge/transition/flow from a common point. The degree of the angle in the angled bent portion may comprise any degree, whether obtuse, acute, right, etc. In various implementations, the base 406 may be bent such that the handle 400 and a bottom side 311 of cutting head 300 form a substantially obtuse angle. In other implementations, the base 406 may be bent such that the handle and the plane of the bottom 311 of the cutting head 300 form any variety of angles. The bent portion 408 of the base 406 may be formed first during manufacture or assembly before welding, molding, flattening, and the like.

In various implementations, the bent portion 408 of the base 406 and the head of the knife itself or the blade end 404 may be subjected to a heat treatment process. The heat treatment process may strengthen the bent knife 100 at those particular points to prevent bending or yielding of the bent knife during use. In particular, the heat treating of the handle 400, and the cutting head 300 may prevent the edge of the blade 200 from cutting through the enclosing sides of the cutting head base, and blade end over time. The heat treatment processes used may include, by non-limiting example, application of a torch flame, electrical heating, oven annealing, and the like.

According to various implementations, the handle 400 may be comprised of a variety of metal, steel, stainless steel, allow steel, electrical conduit tubing, PVC pipes, rubber or any other material or combination of materials useful for making a sturdy and comfortable handle. In various implementations, the handle 400 may be hollow, solid, filled, or any combinations thereof. Other implementations of the handle 400 may comprise a metal covered at least partially by rubber, rubber-like, or plastic material. The handle 400 may be comprised of a single-piece material or a plurality of pieces coupled together in any variety of coupling mechanisms. In the implementation shown in FIGS. 1A-2, the handle 400 comprises a substantially straight single piece of tubing that has a tapered transition area 410 that blends into bent portion 408 and/or the base 406, which also provides for a more precise cut during use in that the tapered transition are allows the blade end of the knife to access more narrow places or the knife to be drawn more flat against a surface.

In various implementations, the length of the handle 400 allows a user to grip the handle with two hands. Such a configuration in combination with the bent base allows the user to have maximum control and strength for cutting material.

The handle 400 may further comprise a cap on the handle end opposite to the blade end where the cutting head and/or blade resides. In the implementation of FIGS. 1A-2, the cap may be found on a substantially straight portion of the handle.

In various implementations, the cutting head 300 may comprise a housing 310, a leaf spring 318 or spring element, and a pin 322. The housing 310 may be comprised of any variety of materials compatible with handle 400 and any variety of shapes. In various implementations, the housing 310 may comprise a shape which provides space between the housing 310 and the base 406. In the implementation depicted in FIG. 1B, the housing 310 comprises a substantially rectangular shape and includes a front edge and chamfered edge 313 on the end/corner nearest the blade 200. Both the front edge and the chamfered edge 313 and even the bottom edge 311 may also be sloped back/beveled/tapered. In other implementations, chamfered edges may be located on any surface, and may be rounded, or have other features and shapes. The blade end 404 and/or base 406 may also comprise a front edge, a chamfered edge, and a bottom edge to match the front edge the chamfered edge 313, and the bottom edge 311 of the housing 320. Both the front edge, the chamfered edge, and the bottom edge may also be sloped back/beveled/tapered. Having the front, chamfered, and bottom edges of the base and housing be sloped back/beveled/tapered provides for a more precise cut during use in that they allow the blade end of the knife to access more narrow places and avoid being hung up on material because of squared or sharp edges.

In various implementations, the housing 310 can comprise a recess 330, and a pin hole 312. The recess 330 can comprise an oblong depression 317 which may comprise two shorter sides of substantially similar dimensions, two longer sides of substantially similar dimensions, and rounded corners. The depression 317 may be angled.

In some implementations, the housing 310 may comprise a single sheet or piece of material with the depression 317 cut into the single sheet. In other implementations, the housing 310 may comprise two sheets or pieces of material coupled together, wherein a first piece has the depression 317 cut into or through the piece and a second piece is substantially solid. In such an implementation, the second piece would form the wall of the housing 310 exposed to the outside, while the first side would form the wall of the housing 310 that contacts the blade and/or base 320.

In various implementations, the housing 310 can be coupled to the base 406 with the leaf spring 318 substantially between the housing and the base and set within the depression. A pin 322 can be inserted into the pin hole 312, and the combination of the pin, the leaf spring 318, and the recess can form an engaging mechanism. The leaf spring 318 may use friction or force to press the blade 200 against the base 406 and/or housing 310, and the blade's notch can lock onto the pin, allowing a user to removably couple the blade 200 to the cutting head 300 and to prevent the blade from falling out loosely.

The depression 317 may be advantageous in various implementations by requiring less force during the insertion of the blade 200 into the cutting head 300, thereby increasing pressure on the blade in both stability positions. Thus, each of the leaf spring 318 and the two longer sides of the oblong depression 317 may be at any variety of angles, such as substantially parallel to a plane formed by the handle 400 of the knife 100. In other implementations, they could be substantially straight or parallel in relation to the cutting head 300. The oblong depression 317 may comprise any two shorter sides of substantially similar dimensions, two longer sides of substantially similar dimensions, and rounded corners.

In various implementations, an engaging mechanism may assist in coupling the blade 200 to the cutting head 300. Engaging mechanisms in various implementations may comprise any elements for either permanently or temporarily securing a blade 200 to the cutting head 300, such as but not limited to washers, leaf springs, magnets, pins, notches, coils, ball bearings, mechanical linkages, screws, bolts and nuts, and the like.

Certain implementations may use friction to press the blade against the base and/or housing. Other implementations may include a pin 322 to lock into notches, holes, or reentrant openings 201 on the blade 200. The pin 322 may prevent the blade 200 from slipping out, falling out loosely, or being pulled out of the cutting head. The pin may require the blade to be rotated out of the cutting head 300 (or angled down and pulled away from the pin and then pulled forward out) instead of just being pulled directly straight out of the cutting head 300.

The engaging mechanism in the implementation of FIGS. 1A-2 may be at least partially enclosed within the housing 310 and the base 406. In this and other implementations, the housing 310 may provide space for the engaging mechanism. The pin 322 may be further configured to also fit within a reentrant opening 201 on the blade 200 and a hole on the base 406. A user may slide blade 200 into the space formed between the base 406 and the housing 310 formed by the recess 330 in the housing 310, and then angle, turn, move, or otherwise manipulate the blade 200 until the pin 322 is within the reentrant and/or notch opening 201 of the blade 200. This allows the blade 200 to be held more securely within the cutting head 300, while also allowing the user to insert or remove the blade 200 without otherwise assembling or disassembling the cutting head 300.

According to various implementations, the blade 200 may comprise a curved, bent, straight or any other shaped razor-type blade configured to cut molding material, fiberglass, or any other material. In the implementation, a typical box-cutter type razor blade 200 is depicted. The blade 200 may further comprise either a single-edged blade or a double-edged blade, and at least one notch. In various implementations, the blade 200 may be permanently coupled to the cutting head 300 and/or base 406. In other implementations, the blade 200 may be removably coupled to the cutting head 300 and/or base 406. As such, some implementations may be sold to the consumer with the blade 200 pre-attached to the cutting head, while in other implementations the blade 200 may be sold unattached or even separate from the cutting head 300 and bent knife 100.

Specifications, Materials, Manufacture, Assembly

It will be understood that implementations are not limited to the specific components disclosed herein, as virtually any components consistent with the intended operation of a bent knife implementation may be utilized. Accordingly, for example, although particular components and so forth, are disclosed, such components may comprise any shape, size, style, type, model, version, class, grade, measurement, concentration, material, weight, quantity, and/or the like consistent with the intended operation of a bent knife implementation. Implementations are not limited to uses of any specific components, provided that the components selected are consistent with the intended operation of a bent knife implementation.

Accordingly, the components defining any bent knife implementation may be formed of any of many different types of materials or combinations thereof that can readily be formed into shaped objects provided that the components selected are consistent with the intended operation of a bent handle cold knife implementation. For example, the components may be formed of: rubbers (synthetic and/or natural) and/or other like materials; glasses (such as fiberglass), carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), neoprene, any combination thereof, and/or other like materials; composites and/or other like materials; metals, such as zinc, magnesium, titanium, copper, iron, steel, carbon steel, alloy steel, tool steel, stainless steel, spring steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Various bent knife implementations may be manufactured using conventional procedures as added to and improved upon through the procedures described here. Some components defining bent knife implementations may be manufactured simultaneously and integrally joined with one another, while other components may be purchased pre-manufactured or manufactured separately and then assembled with the integral components.

Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components.

### Use

Implementations of the bent knife may reduce the likelihood of blade breakage by reducing the torque applied to the cutting edge and increasing the amount of cutting surface used. The bent knife may further allow more force to be applied to the cutting head and allow maintenance of a high level of control of the cutting head while permitting freedom of movement in exerting pressure in both cutting directions. Implementations of the bent knife also allow a user the ability to pull the handle off the blade while in mid cut and reverse the direction of the handle without have to reset the blade within the current cut while keeping the technician in a power position.

In an implementation, the bent knife may be assembled, the handle of the knife frame may be bent. The knife frame or handle may be bent into any variety of shapes or configurations, such but not limited to a hockey stick-like shape. The method then proceeds by flattening substantially one end of a handle to form a base and blade end. Then half of the flattened portion of the base may be removed. Flattening and removing a portion of the blade end and the base may be done with any variety of instruments or tools. Furthermore, in some implementations, the base may be flattened before being coupled to the handle.

The method of assembling a knife frame may further comprise coupling a housing to the base. According to various implementations, the housing may comprise a recess configured to hold a blade between the housing and the base. In an implementation, this coupling of the housing to the base may comprise coupling the housing to one of the flattened surfaces on the base.

It will be understood that the assembly of bent knife implementations are not limited to the specific order of steps as disclosed in this document. Any steps or sequence of steps of the assembly of bent knife implementations indicated herein are given as examples of possible steps or sequence of steps and not as limitations, since various assembly processes and sequences of steps may be used to assemble bent handle cold knife implementations.

Once assembled, the knife frame and blade may be used to cut a variety of materials, such as but not limited to auto body materials, glass, metals, drywall, wood, and the like. In an implementation, the cutting material may be cut by first inserting a blade tip of a blade into the cutting material. In some implementations, this may be after the blade is already removably coupled to the head frame, while in other implementations, the blade may be placed into the cutting material prior to removably coupling the blade to the frame.

The handle may then be gripped with two hands in various implementations. The knife frame may then be removably coupled to the blade by placing a mounting end of the blade into a recess in the housing. Removably coupling the blade to the cutting head may be through the use of pins, leaf spring mechanisms, and the like. Once the blade is removably coupled to the knife frame, the knife frame may be pulled or pushed through the cutting material.

In places where the description above refers to particular implementations, it should be readily apparent that a number of modifications may be made without departing from the spirit thereof and that these implementations may be alternatively applied. The presently disclosed implementations are, therefore, to be considered in all respects as illustrative and not restrictive.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

We claim:

1. A bent knife comprising:
a handle having a holding end and a blade end wherein the blade end comprises a base;
a cutting head having a spring element, and a housing wherein the housing is coupled to the blade end;
a blade having at least one notch; and
an engaging mechanism wherein the engaging mechanism couples the blade to the cutting head.

2. A bent knife according to claim 1, wherein the holding end has a tapered transition at a predetermined distance to the base, wherein the base has a bent portion that leads into the blade end.

3. A bent knife according to claim 2, wherein the base is substantially flattened from about the tapered transition to the blade end.

4. A bent knife according to claim 1, wherein the housing comprises a recess wherein the recess is configured to hold a blade between the housing and the base.

5. A bent knife according to claim 1, wherein the housing further comprises a pin hole and a depression wherein the depression can be substantially oblong comprising of two shorter sides of substantially similar dimensions, two longer sides of substantially similar dimensions, and rounded corners wherein the spring element fits at least partially within the depression.

6. A bent knife according to claim 5, wherein the housing is coupled to the blade end and the base wherein the spring element is substantially in-between the housing, the base, and set within the depression.

7. A bent knife according to claim 5, wherein a pin is coupled with the pin hole inwardly towards the base.

8. A bent knife according to claim 1, wherein the handle comprises a substantially straight piece of tubing that tapers and transitions into a base.

9. A bent knife according to claim 1, wherein the engaging mechanism substantially secures the blade when inserted in-between the base and the housing, wherein the spring element substantially presses against the blade, and the blade engages at least one of the blade's notches.

10. A method of manufacturing a bent knife comprising:
bending a handle;
flattening substantially one end of the handle to form a base, and a cutting end;
removing a portion of the base and the cutting end;
forming a housing with a recess, a depression, and a pin hole;
coupling the housing to the base and cutting end wherein a spring element is placed in the depression and between the housing and the base;
coupling a pin within the pin hole; and
removably placing a blade within the recess wherein the spring element provides a force against the blade, and the pin locks within a notch within the blade.

11. A method of manufacturing a bent knife according to claim 10, wherein the handle, base, cutting end, and housing are integrally formed as one piece.

12. A method of manufacturing a bent knife according to claim 10, wherein the handle, base, cutting end, and housing are forged or casted.
